(19) United States
(12) Patent Application Publication
(10) Pub. No.: US 2016/0279738 A1
(43) Pub. Date: Sep. 29, 2016

(54) LASER MACHINING METHOD AND LASER MACHINING APPARATUS

(71) Applicant: TOYOTA JIDOSHA KABUSHIKI KAISHA, Toyota-shi, Aichi-ken (JP)

(72) Inventors: Mitsutaka YOSHIDA, Nagakute-shi (JP); Takahiro OGAWA, Toyota-shi (JP)

(73) Assignee: TOYOTA JIDOSHA KABUSHIKI KAISHA, Toyota-shi, Aichi-ken (JP)

(21) Appl. No.: 15/033,434

(22) PCT Filed: Nov. 11, 2014
(86) PCT No.: PCT/IB2014/002396

§ 371 Date: Apr. 29, 2016

(30) Foreign Application Priority Data
Nov. 18, 2013 (JP) 2013-237564

(51) Int. Cl. B23K 26/384; B23K 26/03

(52) U.S. Cl. CPC B23K 26/384; B23K 26/032

(57) ABSTRACT

A laser machining method includes forming a through-hole in a workpiece by emitting a laser light; generating image data by taking an image, with a camera, of the workpiece in which the through-hole is formed; and adjusting a hole diameter of the through-hole by enlarging the hole diameter of the through-hole based on the generated image data.

### BACKGROUND OF THE INVENTION

1. Field of the Invention

The invention relates to a laser machining method and a laser machining apparatus.

2. Description of Related Art

Japanese Patent Application Publication No. 3-199907 (JP 3-199907 A) describes technology for forming a through-hole while measuring the through-hole, when forming a through-hole of a predetermined size in a flat plate-like workpiece made of high-strength metal material or ceramic material, using a laser beam. More specifically, the size of the through-hole is measured based on the flow rate per unit time of a fluid flowing through the through-hole. A protective gas such as helium, for example, is supplied to reduce a blocking effect of plasma created by the laser beam being emitted. That is, the fluid that flows through the through-hole is the protective gas.

While the technology described in JP 3-199907 A is able to relatively accurately form the through-hole with the use of a laser beam, there still remains room for improvement with regards to accuracy.

### SUMMARY OF THE INVENTION

The invention thus provides a laser machining method and a laser machining apparatus that accurately forms a through-hole in a workpiece by emitting a laser light.

A first aspect of the invention relates to a laser machining method that includes forming a through-hole in a workpiece by emitting a laser light; generating image data by taking an image, with a camera, of the workpiece in which the through-hole is formed; and adjusting a hole diameter of the through-hole by enlarging the hole diameter of the through-hole based on the generated image data. According to this first aspect of the invention, the through-hole is able to be accurately formed.

In the first aspect of the invention, the workpiece may have a first surface onto which the laser light is emitted, and a second surface on the opposite side of the workpiece to the first surface. Also, the hole diameter of the through-hole in the second surface may be adjusted by enlarging the hole diameter of the through-hole in the second surface based on the generated image data. According to this method, accuracy of the hole diameter of the through-hole in the second surface is able to be achieved. Also, in the first aspect of the invention, the image data may be generated by taking an image, with the camera, of the second surface of the workpiece. According to this method, an image of the hole diameter of the through-hole in the second surface is able to be taken by the camera without difficulty, regardless of the plate thickness of the workpiece. Also, in the first aspect of the invention, when taking the image of the second surface of the workpiece with the camera, an optical axis of the camera may be at an angle with respect to an emitting direction of the laser light. According to this method, an image of the second surface of the workpiece is able to be taken by the camera without difficulty, even while the laser light is being emitted. Alternatively, the laser machining method according to the first aspect of the invention may also include inserting a plate that blocks the laser light between the second surface of the workpiece and the camera, while the laser light is being emitted. According to this method, the camera is able to be prevented from being damaged by the laser light.

In the first aspect of the invention, a plurality of the through-holes may be formed in the workpiece. In JP 3-199907 A, the hole diameter of a through-hole is estimated by measuring the flow rate of a fluid flowing through the through-hole. Therefore, when a plurality of the through-holes are formed in a workpiece, the hole diameters of the plurality of through-holes are unable to be ascertained individually. In contrast, with the method described above, an image of the workpiece is taken by the camera, so the hole diameters of the plurality of through-holes are able to be ascertained individually.

A second aspect of the invention relates to a laser machining apparatus that includes a through-hole forming unit configured to form a through-hole in a workpiece by emitting a laser light; and a camera configured to take an image of the workpiece in which the through-hole is formed and to generate image data of the image of the workpiece. The through-hole forming unit is configured to adjust a hole diameter of the through-hole by enlarging the hole diameter of the through-hole based on the image data generated by the camera. According to this structure, the through-hole is able to be accurately formed.

According to the second aspect of the invention, the workpiece may have a first surface onto which the laser light is emitted, and a second surface that is on the opposite side of the workpiece to the first surface. Also, the through-hole forming unit may be configured to adjust the hole diameter of the through-hole in the second surface by enlarging the hole diameter of the through-hole in the second surface based on the image data generated by the camera. According to this structure, accuracy of the hole diameter of the through-hole in the second surface is able to be achieved. Also, in the second aspect of the invention, the camera may be configured to take an image of the second surface of the workpiece and to generate the image data from the image of the second surface. According to this structure, an image of the hole diameter of the through-hole in the second surface is able to be taken by the camera without difficulty, regardless of the plate thickness of the workpiece. Also, in the second aspect of the invention, an optical axis of the camera when taking the image of the second surface of the workpiece with the camera may be at an angle with respect to an emitting direction of the laser light. According to this structure, an image of the second surface of the workpiece is able to be taken by the camera without difficulty, even while the laser light is being emitted. Alternatively, in the second aspect of the invention, the through-hole forming unit may also include a plate that blocks the laser light by being inserted between the second surface of the workpiece and the camera while the laser light is being emitted. According to this structure, the camera is able to be prevented from being damaged by the laser light.

According to the first and second aspects of the invention, a through-hole is able to be accurately formed in a workpiece by emitting laser light.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a partial sectional view of a fuel injection valve;

FIG. 2 is a plan view of a fuel injection plate;

FIG. 3 is a graph showing the relationship between flow rate of fuel injected from a fuel injection hole, and a hole diameter of an opening of the fuel injection hole;

FIG. 4 is a graph illustrating variation in hole diameter of the opening of the fuel injection hole due to a difference in machining method;

FIG. 5 is an overall view of a laser beam machine according to a first example embodiment of the invention;

FIG. 6 is a view illustrating the relationship between an optical axis of a condenser lens and an optical axis of an area sensor lens according to the first example embodiment;

FIG. 7 is a block diagram of a controller according to the first example embodiment;

FIG. 8 is a view illustrating a machining process, of the fuel injection hole according to the first example embodiment;

FIG. 9 is a flowchart illustrating the operation flow of the laser beam machine according to the first example embodiment;

FIG. 10 is a graph illustrating machining conditions of laser machining according to the first example embodiment;

FIG. 11 is a graph illustrating variation in the hole diameter of the opening of the fuel injection hole according to the first example embodiment;

FIG. 12 is an overall view of a laser beam machine according to a second example embodiment of the invention;

FIG. 13 is a view showing the relationship between an optical axis of a condenser lens and an optical axis of an area sensor lens according to the second example embodiment;

FIG. 14 is a block diagram of a controller according to the second example embodiment; and

FIG. 15 is a flowchart illustrating the operation flow of the laser beam machine according to the second example embodiment.

### DETAILED DESCRIPTION OF EMBODIMENTS

### Fuel Injection Valve 1

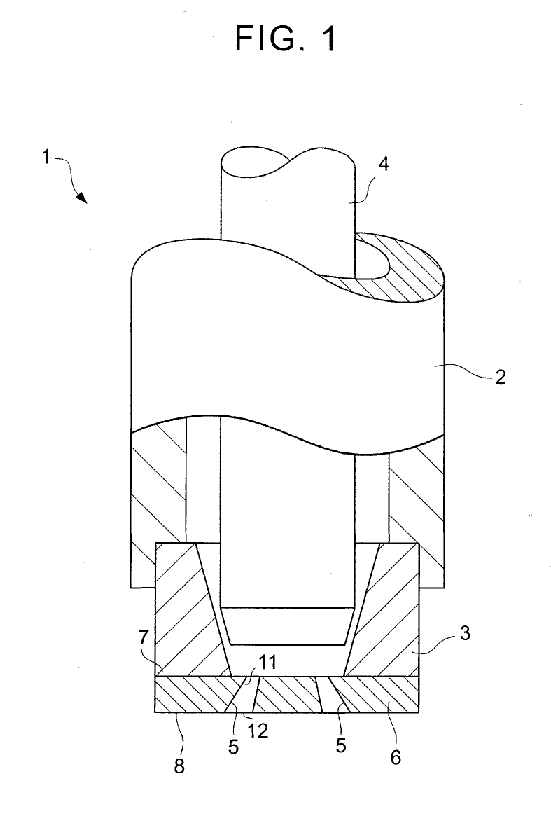

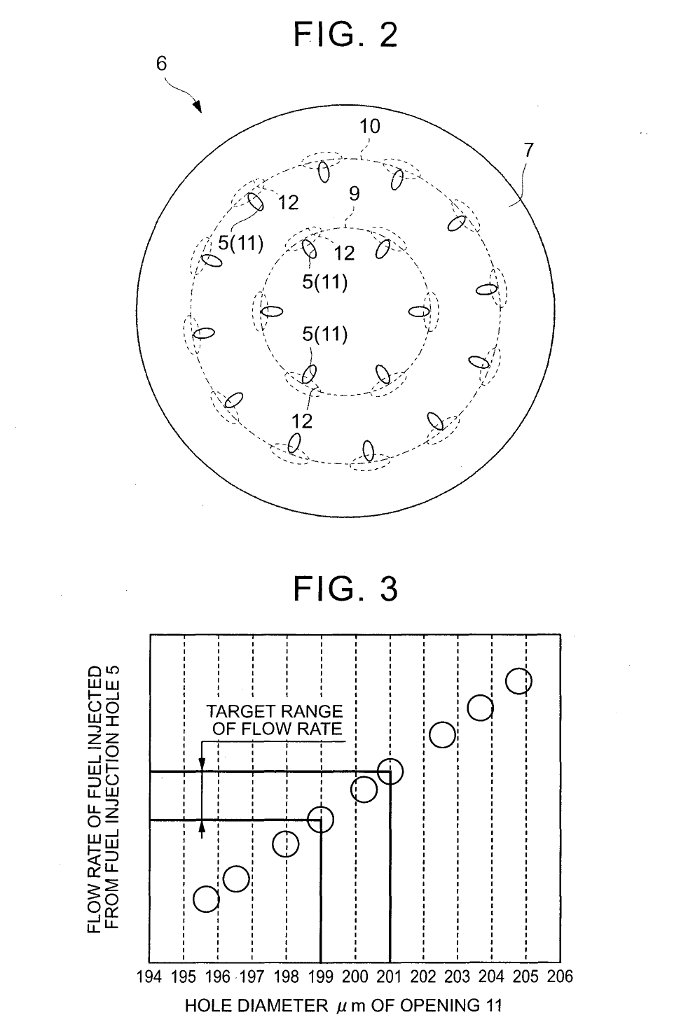

First, a fuel injection valve 1 will be described with reference to FIGS. 1 and 2. As shown in FIG. 1, the fuel injection valve, 1 includes a cylindrical housing 2, an annular valve seat 3, a valve body 4 that is able to advance and retreat inside the housing 2, and a circular plate-like fuel injection plate 6 (i.e., a workpiece to be machined) having a plurality of fuel injection holes 5 (through-holes). Fuel supplied under pressure into the housing 2 is supplied to the fuel injection plate 6 when the valve body 4 moves away from the annular valve seat 3. The fuel injection plate 6 has a plate inner surface 7 (a second surface) that opposes the valve body 4, and a plate outer surface 8 (a first surface) on the opposite side of the fuel injection plate 6 to the plate inner surface 7. The fuel injection plate 6 is 200 to 300 micrometers, for example.

As shown in FIG. 2, the plurality of fuel injection holes 5 are formed lined up in two circles, circle 9 and circle 10, of different diameters. Each fuel injection hole 5 is formed so as to become broader from the plate inner surface 7 toward the plate outer surface 8, as shown in FIGS. 1 and 2. As shown in FIG. 2, an opening 11 of each fuel injection hole 5 in the plate inner surface 7 has an ellipsoid shape when the plate inner surface 7 is viewed from above. The long axis of this ellipsoid shape of the opening 11 is aligned with the radial direction of the fuel injection plate 6. Also, an opening 12 of each fuel injection hole 5 in the plate outer surface 8 has an ellipsoid shape when the plate inner surface 7 is viewed from above. The long axis of this ellipsoid shape of the opening 12 is orthogonal to the radial direction of the fuel injection plate 6. Also, the fuel injection hole 5 is inclined toward an outer peripheral side of the fuel injection plate 6 from the plate inner surface 7 toward the plate outer surface 8, by the opening 12 being formed offset to the outer peripheral side of the fuel injection plate 6 with respect to the opening 11. The hole diameter of the opening 11 of each fuel injection hole 5 is 200 micrometers. Here, the term “hole diameter” may either be defined as the diameter of a true circle that has the same area as the area of the opening 11 when the opening 11 is ellipsoid, or as the long axis or short axis of the opening 11. When the hole diameter is defined by the same length consistently, either definition may be selected as appropriate. The fuel supplied to the fuel injection plate 6 is injected into a cylinder via the fuel injection holes 5.

Through the results of fluid analysis by numerical calculation, the inventors have learned 1) that the hole diameter of the opening 11 of each fuel injection hole 5 is a dominating factor in the variation of the flow rate of fuel injected from the fuel injection hole 5, and 2) that the variation in the hole diameter of the opening 11 of each fuel injection hole 5 must be kept to within ±1 micrometer of a target value, as shown in FIG. 3, in order to satisfy the accuracy for the flow rate that is currently required.

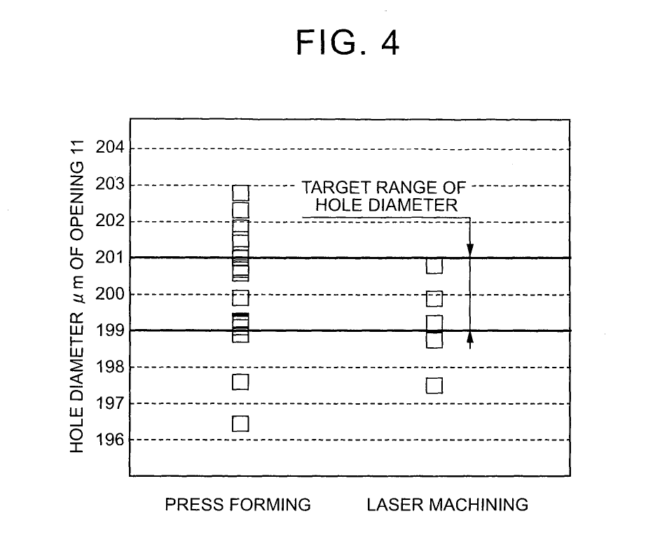

However, with press forming that is typically broadly employed conventionally, the variation in the hole diameter of the opening 11 of each fuel injection hole 5 ends up coming to approximately ±3 micrometers of the target value, as shown in FIG. 4. Therefore, with press forming it is difficult to satisfy the required accuracy, so quality inspection and a correction process after press forming are necessary. Also, even if laser machining is employed instead of press forming, it is difficult to keep the variation in the hole diameter of the opening 11 of each fuel injection hole 5 to within ±1 micrometer of the target value. Therefore, quality inspection and a correction process after press forming are necessary, just as with press forming. This is because even with a laser beam machine, variation in laser output and laser beam diameter, and offset of the optical axis and the like are unavoidable due to time degradation and the like.

Example embodiments of the invention that solves these problems are described below.

### First Example Embodiment

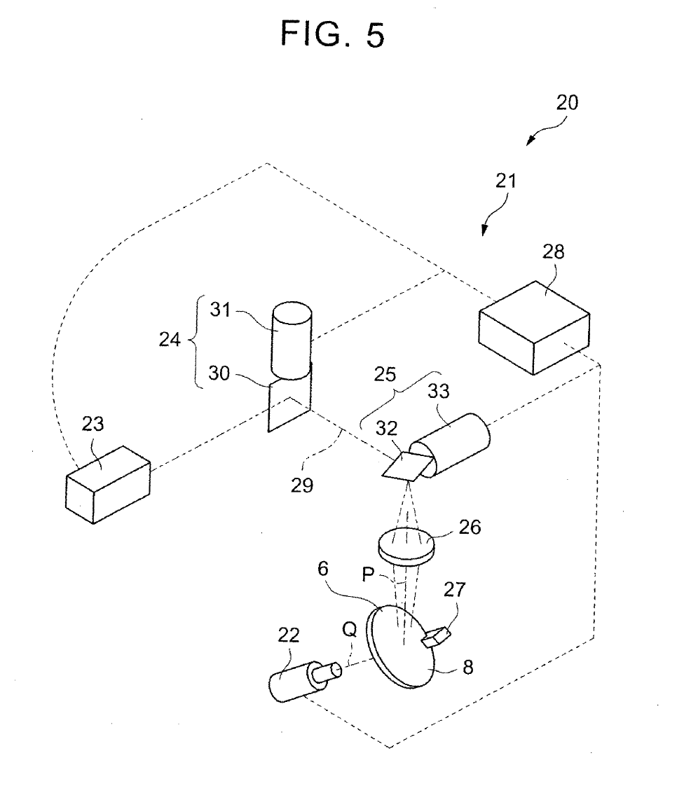

Hereinafter, a first example embodiment of the invention will be described with reference to FIGS. 5 to 11.

A laser beam machine 20 (laser machining apparatus) includes a through-hole forming unit 21 (through-hole forming means), and an area sensor camera 22 (camera, imaging means).

The through-hole forming unit 21 includes a laser oscillator 23, a first galvanometer mirror unit 24, a second galvanometer mirror unit 25, a condenser lens 26, a plate retaining unit 27, and a controller 28.

The laser oscillator 23 is an ultrashort pulsed laser oscillator that outputs laser light 29 as pulsed light such as picosecond laser light, for example.

The first galvanometer mirror unit 24 includes a galvanometer mirror 30 that polarizes the laser light 29, and a mirror motor 31 that rotates the galvanometer mirror 30.

The second galvanometer mirror unit 25 includes a galvanometer mirror 32 that polarizes the laser light 29, and a mirror motor 33 that rotates the galvanometer mirror 32.

The condenser lens 26 is a lens that condenses the laser light 29. The condenser lens 26 has an optical axis P. The direction in which the laser light 29 is emitted (hereinafter, referred to as the “emitting direction”) changes moment by moment when machining the fuel injection hole 5, changing centered around the optical axis P of the condenser lens 26. Therefore, the emitting direction of the laser light 29 may be said to be equivalent to the optical axis P of the condenser lens 26 on the average.

The plate retaining unit, 27 retains the fuel injection plate 6 as the workpiece in such a manner that the fuel injection plate 6 is able to rotate in a circumferential direction. The plate retaining unit 27 has an actuator that rotates the fuel injection plate 6 in the circumferential direction, and a clamp that holds the fuel injection plate 6. The fuel injection plate 6 is retained by the plate retaining unit 27 such that the laser light 29 is emitted onto the plate outer surface 8 at an angle.

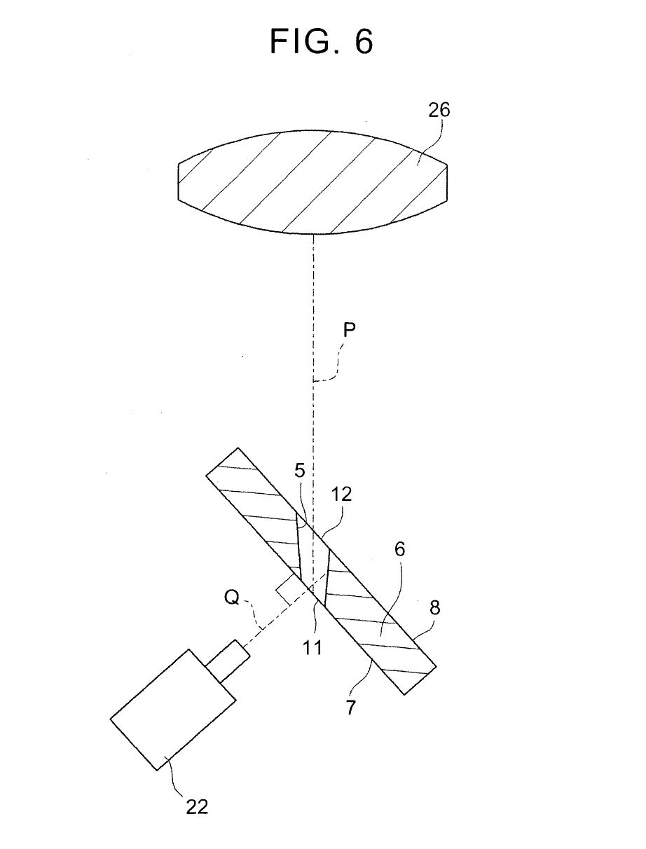

The area sensor camera 22 is a camera having a secondary image sensor and a plurality of lenses. The area sensor camera 22 has an optical axis Q. As shown in FIG. 6, the area sensor camera 22 is arranged on the opposite side of the fuel injection plate 6 to the condenser lens 26, so as to be able to take an image of the plate inner surface 7 of the fuel injection plate 6. The area sensor camera 22 is arranged such that the optical axis Q is orthogonal to the plate inner surface 7 of the fuel injection plate 6. Therefore, the optical axis Q of the area sensor camera 22 is at an angle with respect to the optical axis P of the condenser lens 26.

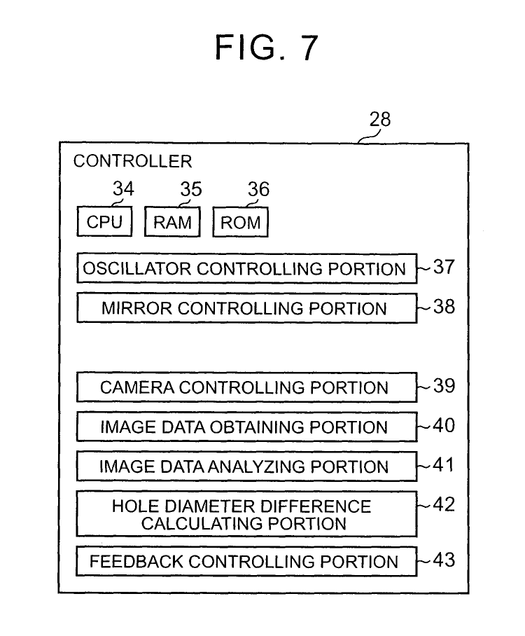

As shown in FIG. 7, the controller 28 is a device that controls the operation of the laser oscillator 23, the first galvanometer mirror unit 24, the second galvanometer mirror unit 25, and the plate retaining unit 27. As shown in FIG. 7, the controller 28 includes a CPU 34 (Central Processing Unit) as a central processing unit, read-writable RAM 35 (Random Access Memory), and read-only ROM 36 (Read Only Memory). The CPU 34 reads and executes a control program stored in the ROM 36. When executed, this control program causes the hardware, i.e., the CPU 34 and the like, to function as an oscillator controlling portion 37, a mirror controlling portion 38, a camera controlling portion 39, an image data obtaining portion 40, an image data analyzing portion 41, a hole diameter difference calculating portion 42, and a feedback controlling portion 43.

The oscillator controlling portion 37 controls the operation (e.g., the output) of the controller 28. The output of the laser oscillator 23 is adjusted by increasing and decreasing the pulse energy and pulse frequency of the laser light 29.

The mirror controlling portion 38 scans the emitting location of the laser light 29 on the fuel injection plate 6 by controlling the operation of the first galvanometer mirror unit 24 and the second galvanometer mirror unit 25.

The camera controlling portion 39 controls the operation of the area sensor camera 22.

The image data obtaining portion 40 obtains image data (imaging data) generated by the area sensor camera 22 and stores it in the RAM 35.

The image data analyzing portion 41 measures the hole diameter of the opening 11 of the fuel injection hole 5 by reading the image data from the RAM 35 and analyzing it, and then stores the hole diameter data in the RAM 35.

The hole diameter difference calculating portion 42 reads the hole diameter data from the RAM 35 and calculates a difference between the hole diameter data and a target value.

The feedback controlling portion 43 feedback-controls the oscillator controlling portion 37 and the mirror controlling portion 38 based on the difference calculated by the hole diameter difference calculating portion 42. More specifically, the feedback controlling portion 43 feedback-controls the oscillator controlling portion 37 and the mirror controlling portion 38 such that the difference calculated by the hole diameter difference calculating portion 42 is less than a predetermined value.

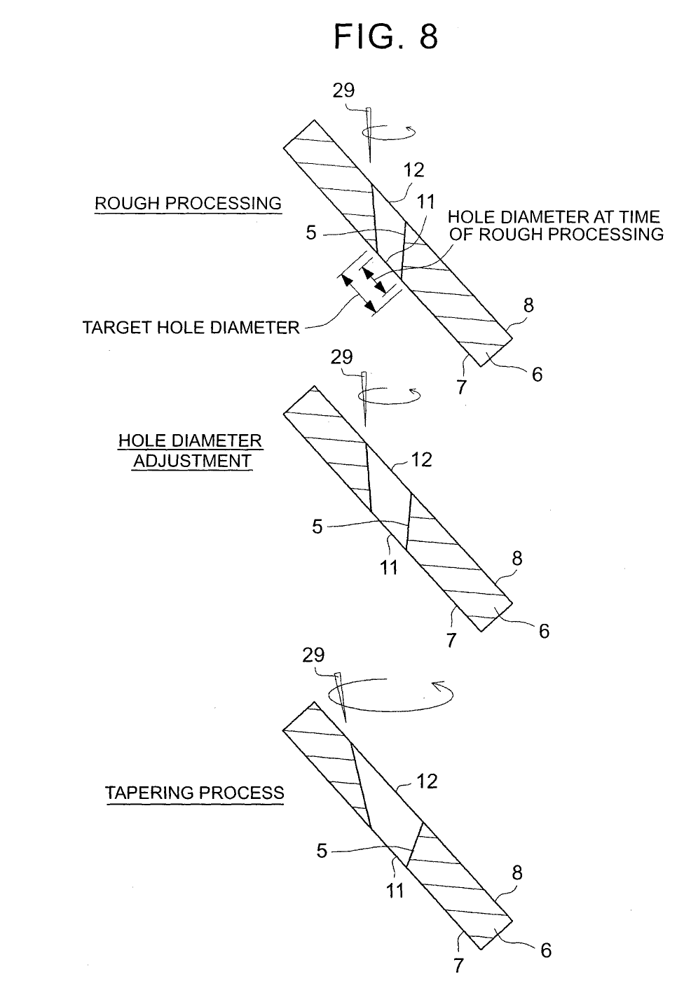

With the structure described above, the emitting location of the laser light 29 is scanned in an elliptical path on the plate outer surface 8 of the fuel injection plate 6, and the fuel injection plate 6 is laser machined, as shown in FIG. 8, by appropriately polarizing the laser light 29 output from the laser oscillator 23 with the first galvanometer mirror unit 24 and the second galvanometer mirror unit 25.

Next, the operation of the laser beam machine 20 will be described with reference to FIGS. 8 to 10.

First, when an operator of the laser beam machine 20 clamps the fuel injection plate 6 to the plate retaining unit 27 and presses a predetermined button (S100), the oscillator controlling portion 37 starts to output the laser light 29 by controlling the laser oscillator 23 (S110, time t0).

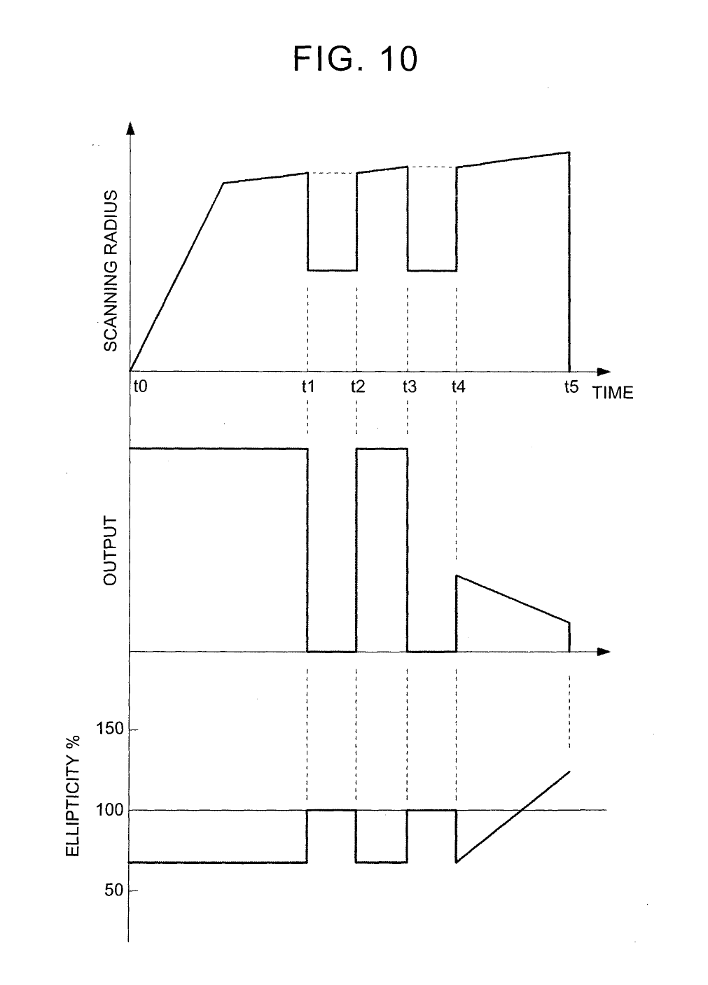

Next, the laser beam machine 20 roughly machines the fuel injection hole 5 in the fuel injection plate 6 (S120, time t0 to t1). That is, the laser beam machine 20 roughly machines the fuel injection hole 5 in the fuel injection plate 6 so that the hole diameter of the opening 11 of the fuel injection hole 5 is 90 to 99% of the target value. More specifically, the scanning radius of the emitting location of the laser light 29 is initially steeply increased from time t0 to t1, and then gradually increased thereafter, as shown in FIG. 10. From time t0 to t1, the output of the laser light 29 is maintained at a predetermined value required to form a through-hole in the fuel injection plate 6. From time to t0 t1, the ellipticity of the opening 11 is maintained at roughly 70%. Here, the term “ellipticity” refers to the ratio of the long axis to the short axis. When the ellipticity is 100%, the opening 11 is a true circle. When the ellipticity is smaller than 100%, and when the ellipticity is larger than 100%, the long axis and the short axis switch places.

Next, the oscillator controlling portion 37 stops the output of the laser light 29 by controlling the laser oscillator 23 (S130, time t1). More specifically, as shown in FIG. 10, at time t1, the scanning radius of the emitting location of the laser light 29 is halved and the output of the laser light 29 is set to zero, such that the ellipticity is 100%.

Next, the hole diameter of the opening 11 of the fuel injection hole 5 is measured (S140, time t1 to t2). More specifically, the laser light 29 outputs an imaging command to the area sensor camera 22 to take an image of the plate inner surface 7 of the fuel injection plate 6. Then the area sensor camera 22 takes an image of the plate inner surface 7 of the fuel injection plate 6, generates image data, and outputs the generated image data to the controller 28. The image data obtaining portion 40 obtains the image data output from the area sensor camera 22 and stores it in the RAM 35. The image data analyzing portion 41 measures the hole diameter of the opening 11 of the fuel injection hole 5 by reading the image data from the RAM 35 and analyzing it, and then stores the hole diameter data in the RAM 35.

Next, the hole diameter difference calculating portion 42 reads the hole diameter data from the RAM 35, and calculates a difference between the hole diameter data and the target value (S150).

Next, the feedback controlling portion 43 feedback-controls the oscillator controlling portion 37 and the mirror controlling portion 38 based on the difference calculated by the hole diameter difference calculating portion 42 (S160 to S210, time t2 to t3). More specifically, the feedback controlling portion 43 feedback-controls the oscillator controlling portion 37 and the mirror controlling portion 38 so that the difference calculated by the hole diameter difference calculating portion 42 is less than the predetermined value (YES in S210).

That is, the oscillator controlling portion 37 controls the laser oscillator 23 to restart the output of the laser light 29 (S160, time t2), and then adjusts the hole diameter of the opening 11 of the fuel injection hole 5 by enlarging the hole diameter of the opening 11 of the fuel injection hole 5 as shown by “hole diameter adjustment” in FIG. 8 (S170, time t2 to t3). As shown in FIG. 10, at time t2, the feedback controlling portion 43 increases the scanning radius of the emitting location of the laser light 29 to a value equal to the scanning radius of the emitting location of the laser light 29 at time t1. Then from time t2 to t3, the feedback controlling portion 43 gradually increases the scanning radius of the emitting location of the laser light 29 so that the obtained difference between the hole diameters disappears. At time t2, the feedback controlling portion 43 increases the output of the laser light 29 to the same value as the output of the laser light 29 at time t1, and maintains this value from time t2 to t3. The feedback controlling portion 43 returns the ellipticity of the opening 11 to roughly 70% at time t2, and maintains this value from time t2 to t3.

Next, the oscillator controlling portion 37 stops the output of the laser light 29 by controlling the laser oscillator 23 (S180, time t3). As shown in FIG. 10, at time t3, the oscillator controlling portion 37 halves the scanning radius of the emitting location of the laser light 29, sets the output of the laser light 29 to zero, and makes the ellipticity 100%.

Next, the hole diameter of the opening 11 of the fuel injection hole 5 is measured (S190).

Next, the hole diameter difference calculating portion 42 reads the hole diameter data from the RAM 35, and calculates a difference between the hole diameter data and a target value (S200).

Next, the feedback controlling portion 43 compares the difference value with a predetermined value (e.g., 1 micrometer), and if it is determined that the difference value is less than the predetermined value (i.e., YES in S210), the process proceeds on to step S220. On the other hand, if it is determined that the difference value is equal to or greater than the predetermined value (i.e., NO in S210), the process returns to step S160.

In step S220, the oscillator controlling portion 37 controls the laser oscillator 23 to restart the output of the laser light 29 (S220, time t4), and then tapers the fuel injection hole 5 of the fuel injection plate 6, as shown by “tapering process” in FIG. 8 (S230). As shown in FIG. 10, at time t4, the scanning radius of the emitting location of the laser light 29 is increased to the same value as the scanning radius of the emitting location of the laser light 29 at time t3, and then gradually increased from time t4 to t5. At time t4, the output of the laser light 29 is increased to around half the output of the laser light 29 at time t3, and then gradually reduced from time t3 to t4. The ellipticity of the opening 11 is returned to roughly 70% at time t4 and then this value is gradually increased to roughly 130% from time t4 to t5. As a result, the fuel injection hole 5 that tapers from the plate outer surface 8 toward the plate inner surface 7 is formed in the fuel injection plate 6.

Next, the oscillator controlling portion 37 controls the laser oscillator 23 to stop the output of the laser light 29 (S240, time t5), and this process ends (S250).

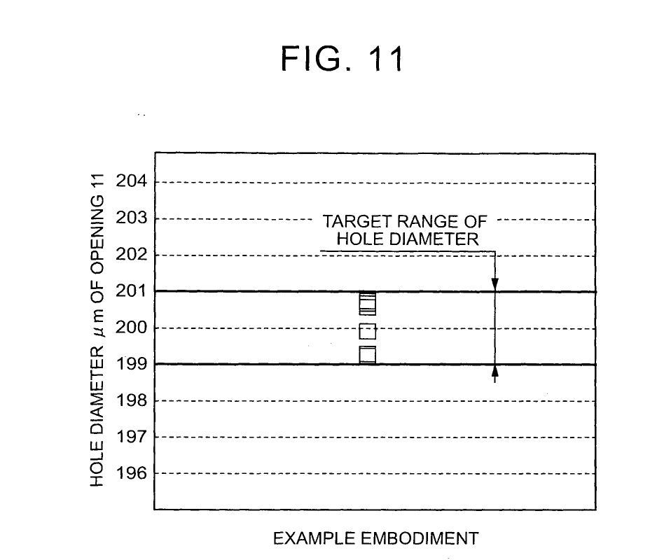

With the laser beam machine 20 described above, variation in the hole diameter of the opening 11 of each fuel injection hole 5 is able to be kept to within ±1 micrometer of the target value, as shown in FIG. 11.

The first example embodiment described above has the characteristics described below.

The laser machining method according to the first example embodiment has a first step (S120) of forming the fuel injection hole 5 (a through-hole) in the fuel injection plate 6 (a workpiece) by emitting the laser light 29, a second step (S140) of taking an image, with the area sensor camera 22, of the fuel injection plate 6 in which the fuel injection hole 5 is formed, and generating image data (imaging data), and a third step (S170) of adjusting the hole diameter of the fuel injection hole 5 by enlarging the hole diameter of the fuel injection hole 5 based on the image data generated in the second step (S140). According to this method, the fuel injection hole 5 is able to be accurately formed. Also, the fuel injection plate 6 has the plate outer surface 8 (i.e., the first surface) onto which the laser light 29 is emitted, and the plate inner surface 7 (i.e., the second surface) on the opposite side of the fuel injection plate 6 to the plate outer surface 8. In the third step (S170), the hole diameter in the plate inner surface 7 of the fuel injection hole 5 is adjusted by enlarging the hole diameter in the plate inner surface 7 of the fuel injection hole 5 based on the image data generated in the second step (S140). According to this method, accuracy of the hole diameter in the plate inner surface 7 of the fuel injection hole 5 is able to be achieved. Moreover, in the second step (S140), an image of the plate inner surface 7 of the fuel injection plate 6 is taken by the area sensor camera 22, and the image data is generated. According to this method, the image of the plate inner surface 7 of the fuel injection plate 6 is able to be taken by the area sensor camera 22 without difficulty, even while the laser light 29 is being emitted. Further, a plurality of the fuel injection holes 5 are formed in the fuel injection plate 6. That is, in JP 3-199907 A, the hole diameter of a through-hole is estimated by measuring the flow rate of a fluid flowing through the through-hole, so when a plurality of the through-holes are formed in a workpiece, the hole diameters of the plurality of through-holes are unable to be ascertained individually. In contrast, with the method described above, an image of the fuel injection plate 6 is taken by the area sensor camera 22, so the hole diameters of the plurality of through-holes are able to be ascertained individually.

The laser beam machine 20 according to the first example embodiment of the invention includes the through-hole forming unit 21 (i.e., through-hole forming means) that forms the fuel injection hole 5 in the fuel injection plate 6 by emitting the laser light 29, and the area sensor camera 22 that is configured to take an image of the fuel injection plate 6 in which the fuel injection hole 5 is formed, and generate image data. The through-hole forming unit 21 is configured to adjust the hole diameter of the fuel injection hole 5 by enlarging the hole diameter of the fuel injection hole 5 based on the image data generated by the area sensor camera 22. According to this structure, accuracy of the hole diameter in the plate inner surface 7 of the fuel injection hole 5 is able to be achieved. Also, the area sensor camera 22 takes an image of the plate inner surface 7 of the fuel injection plate 6, and generates the image data. According to this structure, the image of the hole diameter in the plate inner surface 7 of the fuel injection hole 5 is able to be taken without difficulty, regardless of the plate thickness of the fuel injection plate 6. Further, the optical axis Q of the area sensor camera 22 when an image of the plate inner surface 7 of the fuel injection plate 6 is taken by the area sensor camera 22 is at an angle with respect to the emitting direction of the laser light 29 (i.e., the optical axis P of the condenser lens 26). According to this structure, the area sensor camera 22 is able to take an image of the plate inner surface 7 of the fuel injection plate 6 without difficulty, even while the laser light 29 is being emitted.

A line sensor camera may be used instead of the area sensor camera 22.

Also, a beam rotator using a wedge plate may be used instead of the first galvanometer mirror unit 24 and the second galvanometer mirror unit 25.

### Second Example Embodiment

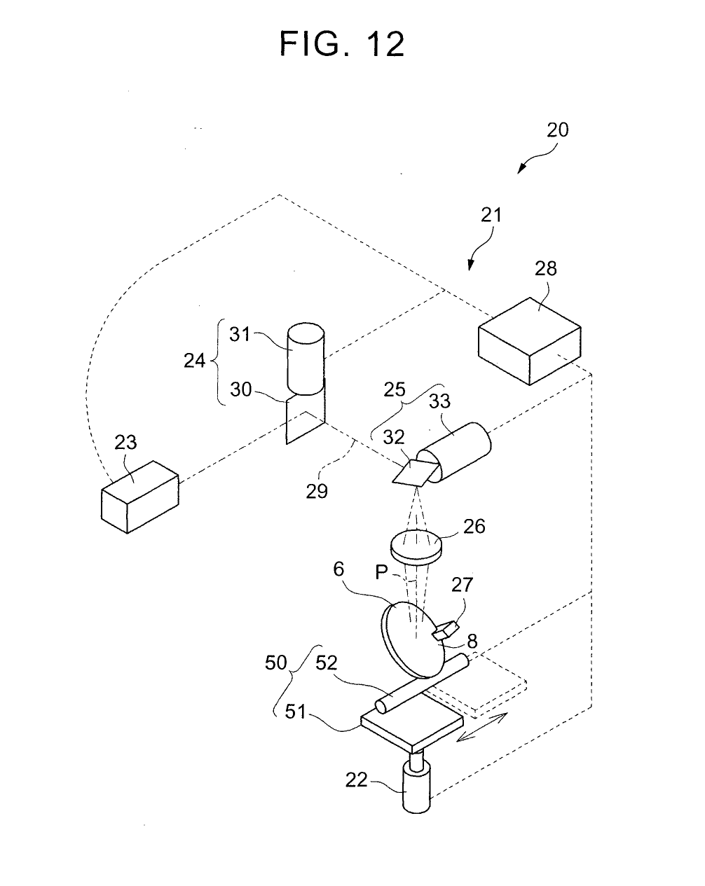

Next, a second example embodiment of the invention will be described with reference to FIGS. 12 to 15. Hereinafter, the second example embodiment will be described focusing on points that differ from the first example embodiment. Redundant descriptions will be omitted.

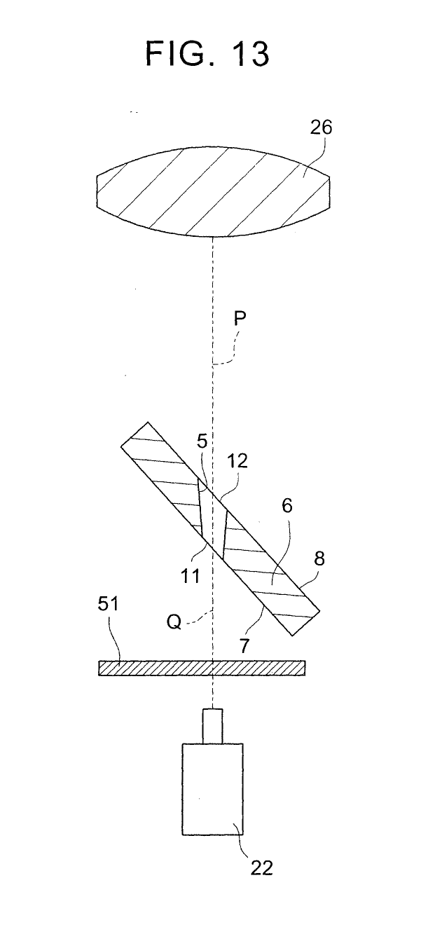

In this example embodiment, the optical axis Q of the area sensor camera 22 is aligned with the emitting direction of the laser light 29 (i.e., the optical axis P of the condenser lens 26), as shown in FIGS. 12 and 13.

The through-hole forming unit 21 also includes a shutter unit 50. The shutter unit 50 has a shutter 51 (a shield or plate), and a shutter actuator 52 (shield driving means). The shutter 51 is a shield that blocks the laser light 29. The shutter actuator 52 is an actuator for inserting the shutter 51 between the condenser lens 26 and the area sensor camera 22, and retracting the shutter 51 from between the condenser lens 26 and the area sensor camera 22.

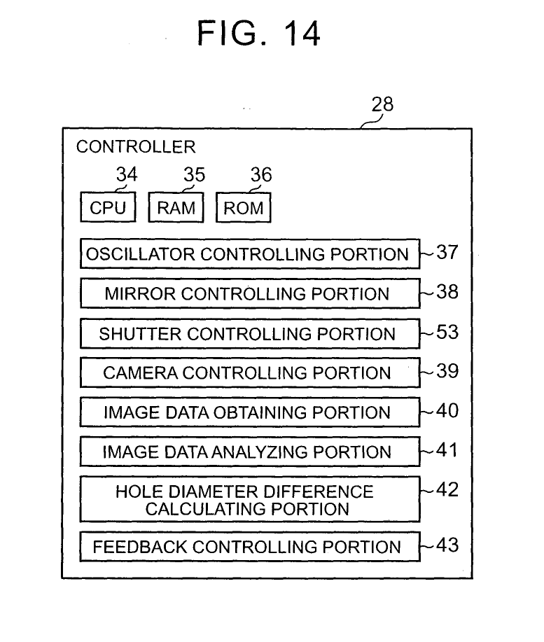

As shown in FIG. 14, the control program in this example embodiment causes the hardware, i.e., the CPU 34 and the like, to also function as a shutter controlling portion 53 (shutter controlling means).

The shutter controlling portion 53 controls the operation of the shutter actuator 52.

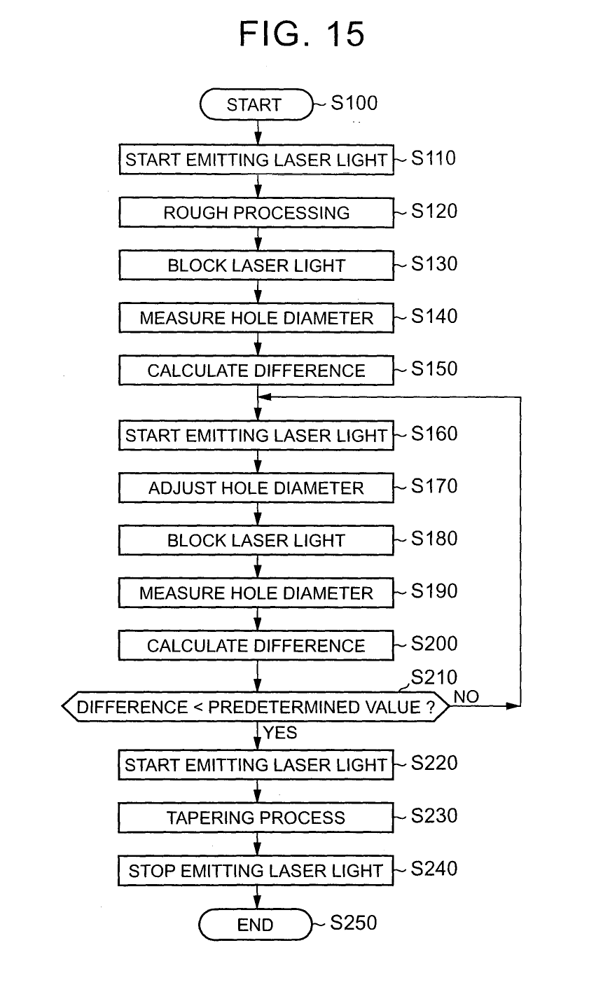

Next, the operation of the laser beam machine 20 will be described with reference to FIG. 15.

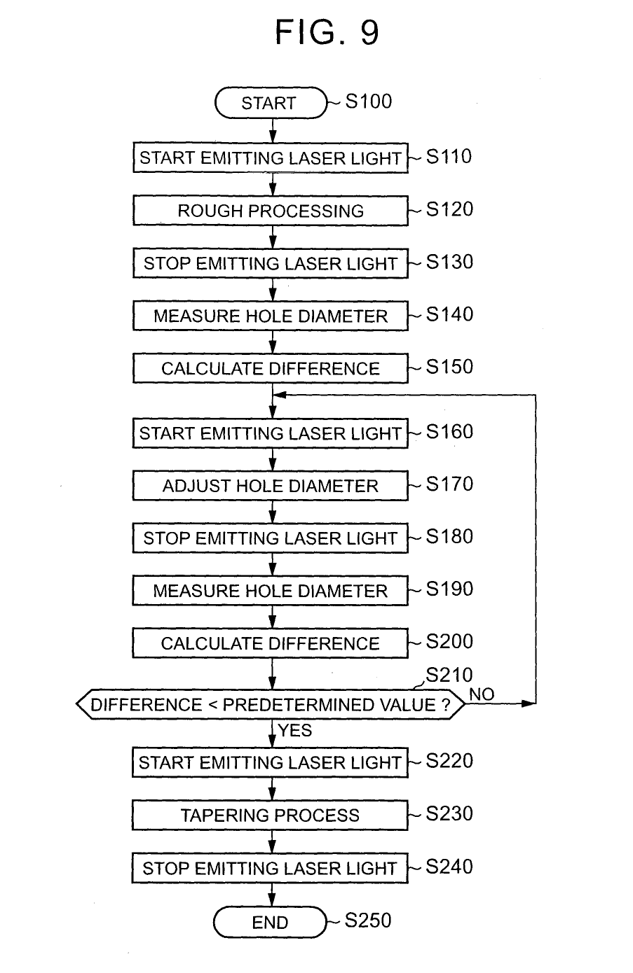

In the first example embodiment, the oscillator controlling portion 37 controls the laser oscillator 23 to stop the output of the laser light 29 in steps S130 and S180, as shown in FIG. 9. However, instead of this, in this example embodiment, the shutter controlling portion 53 controls the shutter actuator 52 to move the shutter 51 to a position where it is able to block the laser light 29 in steps S130 and S180, as shown in FIG. 15.

In the first example embodiment, the oscillator controlling portion 37 controls the laser oscillator 23 to restart the output of the laser light 29 in steps S160 and S220, as shown in FIG. 9. However, instead of this, in this example embodiment, the shutter controlling portion 53 controls the shutter actuator 52 to move the shutter 51 to a position where it will not block the laser light 29 in steps S160 and 220, as shown in FIG. 15.

The second example embodiment described above has the characteristics described below.

While the laser light 29 is being emitted, the shutter 51 (a plate) that blocks the laser light 29 is inserted between the plate inner surface 7 of the fuel injection plate 6 and the area sensor camera 22. According to this method, the area sensor camera 22 is able to be prevented from being damaged by the laser light 29. The laser beam machine 20 also includes the shutter 51 that blocks the laser light 29 by being inserted between the plate inner surface 7 of the fuel injection plate 6 and the area sensor camera 22, while the laser light 29 is being emitted. According to this structure, the area sensor camera 22 is able to be prevented from being damaged by the laser light 29.

1. A laser machining method comprising:
forming a through-hole in a workpiece by emitting a laser light;
adjusting a hole diameter of the through-hole by feedback-control, the feedback-control comprising
generating image data by taking an image, with a camera of the workpiece in which the through-hole is formed and
enlarging the hole diameter of the through-hole based on the generated image data by emitting the laser light; and
tapering the through-hole by emitting the laser light.

2. The laser machining method according to claim 1, wherein
the workpiece has a first surface onto which the laser light is emitted, and a second surface on an opposite side of the workpiece to the first surface; and
the hole diameter of the through-hole in the second surface is adjusted by enlarging the hole diameter of the through-hole in the second surface based on the generated image data.

3. The laser machining method according to claim 2, wherein
the image data is generated by taking an image, with the camera of the second surface of the workpiece.

4. The laser machining method according to claim 3, wherein
when taking the image of the second surface of the workpiece with the camera, an optical axis of the camera is at an angle with respect to an emitting direction of the laser light.

5. The laser machining method according to claim 3, further comprising:
inserting a plate that blocks the laser light between the second surface of the workpiece and the camera, while the laser light is being emitted.

6. The laser machining method according to claim 1, wherein
a plurality of the through-holes is formed in the workpiece.

7. A laser machining apparatus comprising:
a through-hole forming unit configured to form a through-hole in a workpiece by emitting a laser light; and
a camera configured to take an image of the workpiece in which the through-hole is formed and to generate image data of the image of the workpiece, wherein
the through-hole forming unit comprises a feedback controlling portion configured to adjust a hole diameter of the through-hole by feedback control comprising generating the image data by the camera and enlarging the hole diameter of the through-hole based on the image data generated by the camera by emitting the laser light, wherein
the through-hole forming unit is further configured to taper the through-hole by emitting the laser light.

8. The laser machining apparatus according to claim 7, wherein
the workpiece has a first surface onto which the laser light is emitted, and a second surface that is on an opposite side of the workpiece to the first surface; and
the through-hole forming unit is configured to adjust the hole diameter of the through-hole in the second surface by enlarging the hole diameter of the through-hole the second surface based on the image data generated by the camera.

9. The laser machining apparatus according to claim 8, wherein
the camera is configured to take an image of the second surface of the workpiece and to generate the image data from the image of the second surface.

10. The laser machining apparatus according to claim 9, wherein
an optical axis of the camera when taking the image of the second surface of the workpiece with the camera is at an angle with respect to an emitting direction of the laser light.

11. The laser machining apparatus according to claim 10, wherein
the through-hole forming unit has a plate retaining unit configured to retain the second surface of the workpiece at an angle with respect to the emitting direction of the laser light.

12. The laser machining apparatus according to claim 9, wherein
the through-hole forming unit further includes a plate that blocks the laser light by being inserted between the second surface of the workpiece and the camera while the laser light is being emitted.
